(19) United States
(12) Patent Application Publication
(10) Pub. No.: US 2014/0176502 A1
(43) Pub. Date: Jun. 26, 2014

(54) IMAGE DISPLAY APPARATUS AND METHOD

(71) Applicant: Korea Electronics Technology Institute, Gyeonggi-do (KR)

(72) Inventors: Young Min KIM, Seoul (KR); Byoung Ha PARK, Seoul (KR); Yang Keun AHN, Seoul (KR); Kwang Mo JUNG, Gyeonggi-do (KR)

(73) Assignee: Korea Electronics Technology Institute, Gyeonggi-do (KR)

(21) Appl. No.: 13/952,227

(22) Filed: Jul. 26, 2013

(30) Foreign Application Priority Data
Dec. 20, 2012 (KR) 10-2012-0149634

(51) Int. Cl. G06F 3/01; G06F 3/03

(52) U.S. Cl. CPC G06F 3/016; G06F 3/0304
USPC 345/175

(57) ABSTRACT

The present invention relates to an image display apparatus and method for displaying a three-dimensional (3D) image capable of interacting with a user, and provides a 3D image display apparatus and method that may interact with a user by reproducing a 3D image, generated by a conventional volume display apparatus, at a position different from a position at which the 3D image is generated, and by modifying and playing the reproduced 3D image based on a motion of the user. Also, the present invention enables the user to realistically interact with the 3D image by stimulating tactile sensation of the user through ultrasound.

### CROSS-REFERENCE TO RELATED APPLICATIONS

This application claims priority under 35 U.S.C. §119 to Korean Patent Application No. 10-2012-0149634, filed on Dec. 20, 2012, in the Korean Intellectual Property Office, the disclosure of which is incorporated herein by reference in its entirety.

### TECHNICAL FIELD

The present invention relates to an image display apparatus and method for playing a three-dimensional (3D) image, and particularly, to an image display apparatus and method that enables a user to interact with a 3D image being played.

### BACKGROUND

Most conventional autostereoscopic three-dimensional (3D) displays capable of performing interaction employs a scheme of interacting with a user by using a parallax barrier, a lenticular lens, and the like, and by enabling the user to observe a 3D image on a front surface of a panel.

In such autostereoscopic 3D display, an optical device is disposed on a front surface of a display to thereby display a directional-view image, and a 3D image capable of performing interaction is played based on a motion of an observer recognized using a motion recognition camera.

However, the above method has a problem in that the observer may not realistically observe the 3D image, and has a limitation of playing a two-dimensional (2D) image since an image is not an actual 3D image but a directional-view image. Also, the observer performs interaction while observing a flat display on which the 3D image is displayed. Accordingly, there is a problem in that it is difficult for a plurality of observers to perform interaction. The above method also has a disadvantage in that an angle of view is very limited. Accordingly, there is a need to improve the above problems.

The conventional volume display scheme capable of performing interaction employs a method in which an observer may not directly touch or control a 3D image and an image is displayed by recognizing a motion in such a manner that the observer wears an auxiliary tool. Accordingly, there is a disadvantage in that tension of the user is decreased.

### SUMMARY

An exemplary embodiment of the present invention provides an image display apparatus, including: a display generating unit configured to generate a three-dimensional (3D) image; an optical processing unit configured to reproduce the 3D image at a position different from a position at which the 3D image is generated; a motion receiving unit configured to receive a motion of a user with respect to the 3D image reproduced by the optical processing unit; and an image processing unit configured to modify the reproduced 3D image based on the motion of the user, and to play the modified 3D image.

According to an aspect of the present invention, the optical processing unit reproduces the 3D image using a mirror or a lens, and in this instance, enables the user to omni-directionally observe the reproduced 3D image by disposing a parabolic optical mirror and elevating the reproduced 3D image.

According to another aspect of the present invention, the image display apparatus further includes an ultrasound generating unit. The ultrasound generating unit enables the user to recognize tactile sensation by concentrating ultrasound on a portion where the reproduced 3D image is displayed, when the user interacts with the reproduced 3D image.

Another exemplary embodiment of the present invention provides an image display method, including: generating and playing a 3D image; reproducing the 3D image at a position different from a position at which the 3D image is played; receiving a motion of a user with respect to the reproduced 3D image; modifying the reproduced 3D image based on the motion of the user, and playing the modified 3D image; and enabling the user to recognize tactile sensation using ultrasound, when the user interacts with the reproduced 3D image.

Other features and aspects will be apparent from the following detailed description, the drawings, and the claims.

### BRIEF DESCRIPTION OF THE DRAWINGS

FIG. 1 is a block diagram illustrating a structure of an image display apparatus according to an exemplary embodiment of the present invention.

FIG. 2 is a diagram illustrating an example of operating an image display apparatus according to an exemplary embodiment of the present invention.

FIG. 3 is a flowchart illustrating a process of an image display method according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Advantages and features of the present invention and a method for achieving the same will become explicit by referring to the exemplary embodiments that are described in detail in the following with reference to the accompanying drawings. However, the present invention is not limited to the exemplary embodiments disclosed in the following and thus, may be configured in various forms. Here, the present exemplary embodiments are provided to make the disclosure of the present invention perfect and to completely inform those skilled in the art about the scope of the present invention. The present invention is defined by the scope of claims.

Meanwhile, terminologies used in the present specification are to describe the exemplary embodiments and not to limit the present invention. In the present specification, unless particularly described in the description, a singular form includes a plural form. “Comprises/includes” and/or “comprising/including” used in the specification does not exclude the presence or addition of at least one another constituent element, step, operation, and/or device with respect to the described constituent element, step, operation/or device. Hereinafter, the exemplary embodiments of the present invention will be described in detail with reference to the accompanying drawings.

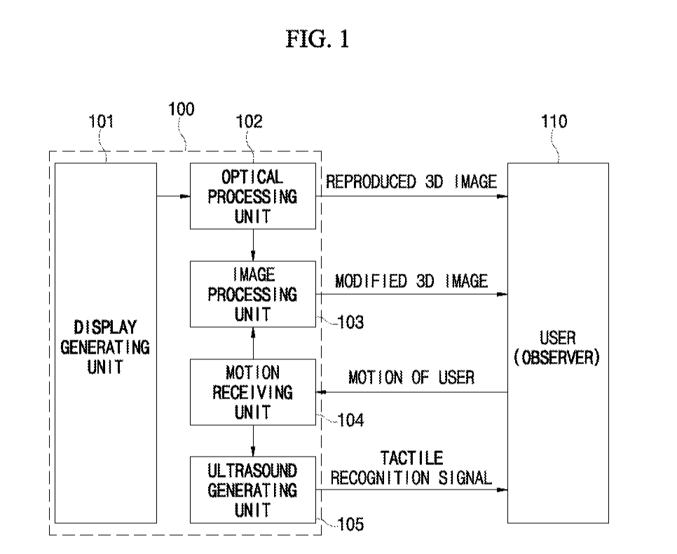

FIG. 1 is a block diagram illustrating a structure of an image display apparatus 100 according to an exemplary embodiment of the present invention.

The image display apparatus 100 according to an exemplary embodiment of the present invention includes a display generating unit 101, an optical processing unit 102, an image processing unit 103, a motion receiving unit 104, and an ultrasound generating unit 105.

The display generating unit 101 generates a three-dimensional (3D) image desired to be displayed through the image display apparatus 100. Accordingly, in order to generate the 3D image, the display generating unit 101 includes constituent elements included in a conventional volume display apparatus. The display generating unit 101 transfers the generated 3D image to the optical processing unit 102.

The optical processing unit 102 receives the 3D image generated by the display generating unit 101, and reproduces the generated 3D image at a position different from a position at which the 3D image is generated, so that a user (observer) 110 may interact with the 3D image.

The optical processing unit 102 includes a mirror or a lens to make it possible to reproduce the 3D image at the position different from the position at which the 3D image is generated. As an exemplary embodiment in which the optical processing unit 102 reproduces the 3D image at the position different from the position at which the 3D image is generated, the optical processing unit 102 enables the user 110 to omni-directionally observe the 3D image and to interact with the 3D image by disposing a parabolic optical mirror and elevating the reproduced 3D image.

The motion receiving unit 104 receives a motion of the user 110 to interact with the user 110, and transfers the received motion to the image processing unit 103. The motion receiving unit 104 includes an image sensor, a camera, and the like, and receives a behavior, a facial expression, a gaze, and the like of the user 110 through the image sensor, the camera, and the like.

The image processing unit 103 modifies the 3D image reproduced by the optical processing unit 102, based on the motion of the user 110 received from the motion receiving unit 104, and plays the modified 3D image. Accordingly, the image processing unit 103 receives the reproduced 3D image from the optical processing unit 102, and modifies the reproduced 3D image based on the behavior, the facial expression, the gaze, and the like of the user 110 that is transferred from the motion receiving unit 104, and plays the modified 3D image so that the user 110 may view the modified 3D image.

The ultrasound generating unit 105 enables the user 110 to feel tactile sensation on a predetermined portion of a body of the user 110, when the user 110 interacts with the 3D image reproduced by the optical processing unit 102 or the 3D image modified by the image processing unit 103. To provide the user 110 with the tactile sensation, the ultrasound generating unit 105 generates ultrasound and concentrates the ultrasound on a portion where the 3D image is displayed. Accordingly, the user 110 may recognize the tactile sensation.

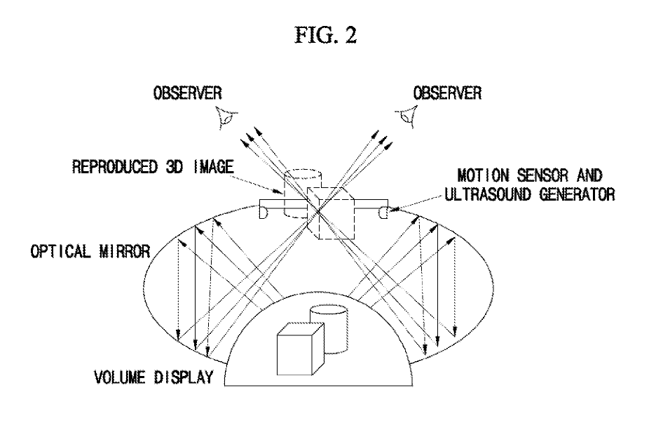

FIG. 2 is a diagram illustrating an example of operating an image display apparatus according to an exemplary embodiment of the present invention.

As illustrated in FIG. 2, the user 110 is enabled to perform interaction through the motion receiving unit 104, such as a sensor, a camera, and the like capable of detecting a motion, which is disposed around or above/below an optical mirror. The image display apparatus detects a motion signal of the user 110, and enables the user 110 to feel tactile sensation through an ultrasound generator installed around or above/below the optical mirror.

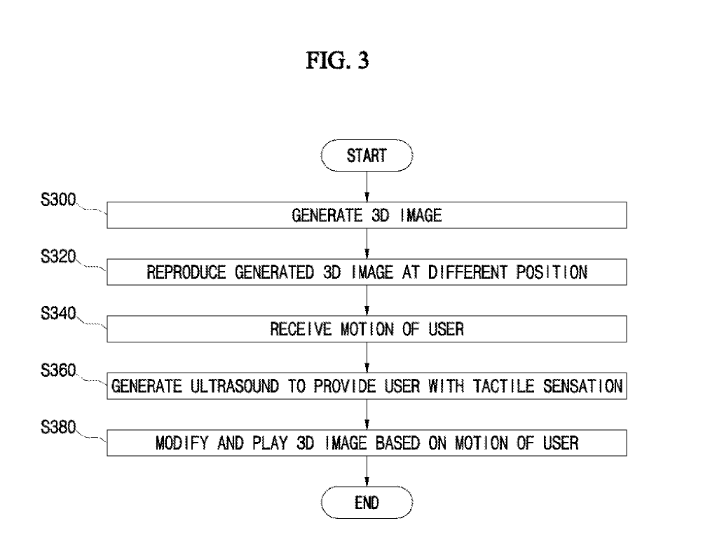

FIG. 3 is a flowchart illustrating a process of an image display method according to an exemplary embodiment of the present invention.

An image display apparatus according to an exemplary embodiment of the present invention generates a 3D image (S300), and reproduces the generated 3D image at a position different from a position at which the 3D image is generated, so that the user may interact with the generated 3D image (S320).

The reproduced 3D image interacts with the user. Accordingly, the image display apparatus receives a motion of the user, such as a behavior, a facial expression, a gaze, and the like, that are performed by the user with respect to the 3D image (S340), and reflects the received motion of the user to the 3D image.

Here, the image display apparatus provides the user with tactile sensation and reproduces a realistic 3D image by generating ultrasound through an ultrasound generator in order to enable the user interacting with the 3D image to recognize the tactile sensation, and by concentrating the ultrasound on a portion where the 3D image is displayed (S360).

The image display apparatus enables the user to continuously interact with the 3D image by modifying the 3D image based on the received motion of the user and by playing the modified 3D image (S380).

According to exemplary embodiments of the present invention, there is provided an autostereoscopic 3D image that may be omni-directionally observed and may perform interaction, which is different from a conventional autostereoscopic 3D display capable of performing interaction.

Also, according to exemplary embodiments of the present invention, there is provided a sensuous image display apparatus and method that enables a plurality of observers to interact with each other and may provide even tactile sensation of a user.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image display apparatus, comprising:
a display generating unit configured to generate a three-dimensional (3D) image;
an optical processing unit configured to reproduce the 3D image;
a motion receiving unit configured to receive a motion of a user with respect to the 3D image reproduced by the optical processing unit; and
an image processing unit configured to modify the reproduced 3D image based on the motion of the user, and to play the modified 3D image.

2. The apparatus of claim 1, wherein the optical processing unit reproduces the 3D image at a position different from a position at which the 3D image is generated.

3. The apparatus of claim 1, wherein the optical processing unit reproduces the 3D image using a mirror or a lens.

4. The apparatus of claim 1, wherein the optical processing unit enables the user to omni-directionally observe the reproduced 3D image by disposing a parabolic optical mirror and elevating the reproduced 3D image.

5. The apparatus of claim 1, wherein the motion receiving unit includes an image sensor or a camera, and receives a behavior, a facial expression, or a gaze of the user through the image sensor or the camera.

6. The apparatus of claim 1, further comprising:
an ultrasound generating unit configured to enable the user to recognize tactile sensation by concentrating ultrasound on a portion where the reproduced 3D image is displayed, when the user interacts with the reproduced 3D image.

7. An image display method, comprising:
generating and playing a 3D image;
reproducing the 3D image at a position different from a position at which the 3D image is played;
receiving a motion of a user with respect to the reproduced 3D image; and
modifying the reproduced 3D image based on the motion of the user, and playing the modified 3D image.

8. The method of claim 7, further comprising:
enabling the user to recognize tactile sensation using ultrasound, when the user interacts with the reproduced 3D image.
